(19) United States
(12) Patent Application Publication
(10) Pub. No.: US 2013/0151362 A1
(43) Pub. Date: Jun. 13, 2013

(54) System and Method of Express Purchasing

(71) Applicant: Nir Steel, Lauderhill, FL (US)

(72) Inventor: Nir Steel, Lauderhill, FL (US)

(21) Appl. No.: 13/314,127

(22) Filed: Dec. 7, 2011

(51) Int. Cl. G06Q 30/06

(52) U.S. Cl. 705/26.1

(57) ABSTRACT

This invention relates to a system and method of express purchasing comprising a receptacle for holding items for purchase; a scaling area capable of weighing said receptacle before items are placed inside and after shopping for items is complete; means for identifying items for purchase; means for remote purchasing; and a central computer linking said means for identifying items for purchase to said means for remote purchasing and said scaling area. This system and method provides for a much expedited manner of shopping and checking out so that a customer avoids long lines to purchase items.

### CROSS-REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A COMPACT DISC

Not Applicable.

### BACKGROUND OF THE INVENTION

This invention elates to the system and method of express purchasing. While shopping, typically in grocery stores but other stores may also have this similar problem, long lines are encountered during the checkout process. A cashier has to manually scan each item which is a slow and laborious process. This results in a significant loss of a customer's time and increases stress levels and frustration in customers. Further some customers may have problems with prices as they are scanned which further slow a cashier in this process and delay movement of other customers through the line. When this occurs, customers may leave a store with a negative opinion of the store and may be deterred from shopping there in the future. This has the undesirable result of loss of income for a store.

Many inventions have been developed to help assist in this problem, such as U.S. Pat. No. 4,071,740 ('470) and U.S. Pub. No. 20110036907. These inventions contemplated affixing a scanning and weighing element linked to a central computer to a shopping cart so that a customer could walk through a store and scan the items for purchase while shopping and prior to checking out. The weighing element acts as a type of security as it ensures that the item placed in the cart weighs the same as the item scanned. The customer simply brings a receipt to the checkout counter for purchase.

Other inventions require tagging all items with RFID or other “intelligent” forms of tagging so that a scanner can easily read what is placed into a cart and a receipt can quickly be generated to speed the checkout process.

The problem with many of the known inventions in this field is that it is expensive for a store to fit all shopping carts with a physical device for scanning in advance of reaching the checkout line. Stores, particularly grocery stores or other general stores, are in constant competition to lower prices and devices that are known to the market are simply too expensive to integrate. Adapting the above known proposed devices causes bulky operation for the store and the possibility of greater monetary loss due to theft of shopping carts (a common event for stores), therefore the prior art inventions are unlikely to be adopted by stores. This invention provides for a low cost way to speed the checkout process for consumers without adding a significant cost burden to the store.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### BRIEF SUMMARY OF THE INVENTION

This invention relates to a system and method of express purchasing comprising a receptacle for holding items for purchase;

a security means capable of ensuring items in receptacle are the items purchased; means for identifying items for purchase;

means for remote purchasing; and

a central computer linking said means for identifying items for purchase to said means for remote purchasing and said security means.

The receptacle for holding items for purchase may be a shopping cart, basket or other similar receptacle commonly used while shopping. One skilled in the art will recognize that different stores may have different needs in a receptacle being used. While this invention will be described in terms of a shopping cart, commonly used in a grocery store, one skilled in the art will recognize that any receptacle in any type of store is anticipated.

When a customer enters a store, he or she activates the means for identifying items for purchase. In a preferred embodiment, the means for identifying items for purchase is a cell phone or similar device that is equipped with application software (“app”) and is able to scan a tag identifying means, such as a bar code associated with the receptacle. After the customer scans the tag identifying means and the receptacle is associated with the customer, the customer is checked through the security means. While many methods of security are envisioned, one preferred embodiment takes the customer to a scaling area before shopping begins. The customer places the receptacle onto the scaling area. This measures the weight of the receptacle prior to shopping. The scaling area is equipped with a weight activation sensor so as soon as weight is sensed, it performs the weighing function. The means for identifying items for purchase recognizes the weight of the receptacle and stores this information for later use (during purchasing process). This allows the customer to have his/her means for identifying items to be associated with a receptacle and its pre-purchase weight. One skilled in the art will recognize that other types of means for identifying items for purchase are contemplated, such as a personal digital assistant (“PDA”), tablet computers, or other small hand held devices. The means for identifying items for purchase simply needs to have a capacity to read information about an item. Further, it is anticipated that the receptacle may be equipped with a device for holding the means for identifying items for purchase. While it is anticipated that a customer will bring a means for identifying items for purchase to the store, it is also anticipated that the store could provide this device for a customer to use while in the store.

The app contained within the means for identifying items for purchase is software that is linked to a central store computer. Once the means for identifying items for purchase activates its end of the software, typically by scanning the tag identifier on the receptacle and registering an initial weight, the central store computer recognizes that it is on and capable of operating in conjunction with the central store computer.

As a customer shops in a store, he/she selects items for purchase. Before the items are placed in to the receptacle, the customer uses the means for identifying items for purchase in order to place the item into the software for purchase. The items are scanned for a tag identifier which is associated with the item and holds relevant information about the items, such as price, weight, or a description of the item. One skilled in the art will recognize that any information about the item can be programmed by the store's central computer to appear to a customer when scanned.

It is also envisioned that a customer will be able to pre-load a shopping list to the app that would communicate with the store's central computer to assist in the shopping process. If a shopping list is preloaded, the app would help locate items within the store for the customer. This could be done by sensing where items (using RFID or similar technology) are located or simply providing aisle locations of the item.

The tag identifier may be a Universal Product Code (“UPC”), radio frequency identifier (“RFID) tags, bar codes or any other similar tagging mechanism that is capable of being read by the means for identifying items for purchase.

After an item is scanned and the customer still wishes to purchase the item, it is placed into the receptacle. This is repeated for each item until the customer has concluded his or her shopping. If a customer no longer wishes to purchase an item, the means for identifying items for purchase can also be used to delete an item. All of the items that the customer wishes to purchases are logged in the app, including but not limited to the item price and weight.

When a customer has finished shopping and has all of the desired items scanned and in the receptacle, the customer heads back to the security means to identify that the items in the receptacle are the items the customer is purchasing. In one preferred embodiment where a scaling are is utilized, the customer brings the receptacle back to the scaling area for a second weighing. This second weighing of the receptacle serves to confirm the weight of the items and receptacle compared to the weight of the logged items in the receptacle. This second weighing is an important security feature to ensure that a customer is being accurately charged for the items desired to be purchased. Once the central computer verifies that the data logged within the means for identifying items for purchase is accurate, the customer proceeds to checkout and purchase the items.

Checkout can occur in a variety of manners. The preferred manner of checkout occurs by a means of remote purchasing. This means for remote purchasing are preferably incorporated within the application software within the means for identifying items for purchase. The means for remote purchasing can utilize a credit card or a debit from a bank account to complete the purchase. Once payment has been confirmed, the customer is free to leave the store with the purchased items.

One skilled in the art will note that it is also possible to pre-pay for items before shopping so long as the items paid for are confirmed to be the items in the receptacle by the security means.

### BRIEF DESCRIPTION OF THE SEVERAL VIEWS OF THE DRAWINGS

Possible and preferred features of the present invention will now be described with particular reference to the accompanying drawings. However, it is to be understood that the features illustrated in and described with reference to the drawings are not to be construed as limiting on the broad scope of the invention. In the drawings:

FIG. 1 depicts the empty receptacle prior to initial weigh in.

FIG. 2 depicts the receptacle on the scaling area and the means for identifying items.

FIG. 3 depicts an item being scanned before being placed into the receptacle.

FIG. 4 depicts items inside the receptacle on the scaling area for the final weighing as a customer is about to checkout.

### DETAILED DESCRIPTION OF THE INVENTION

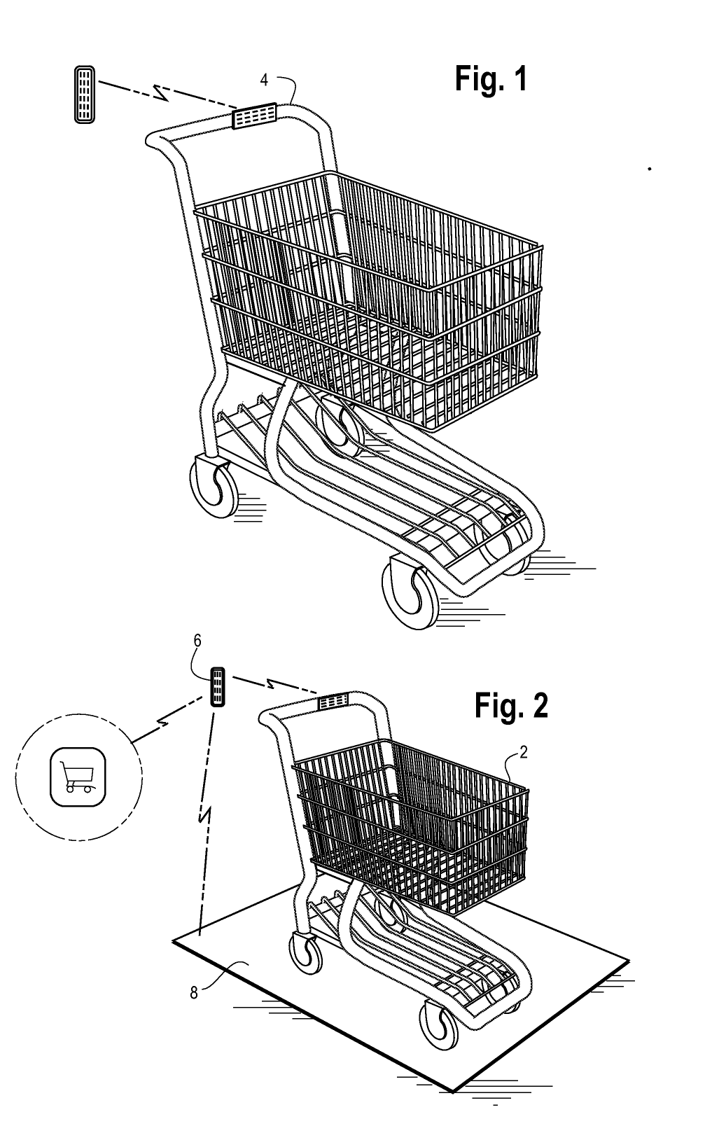

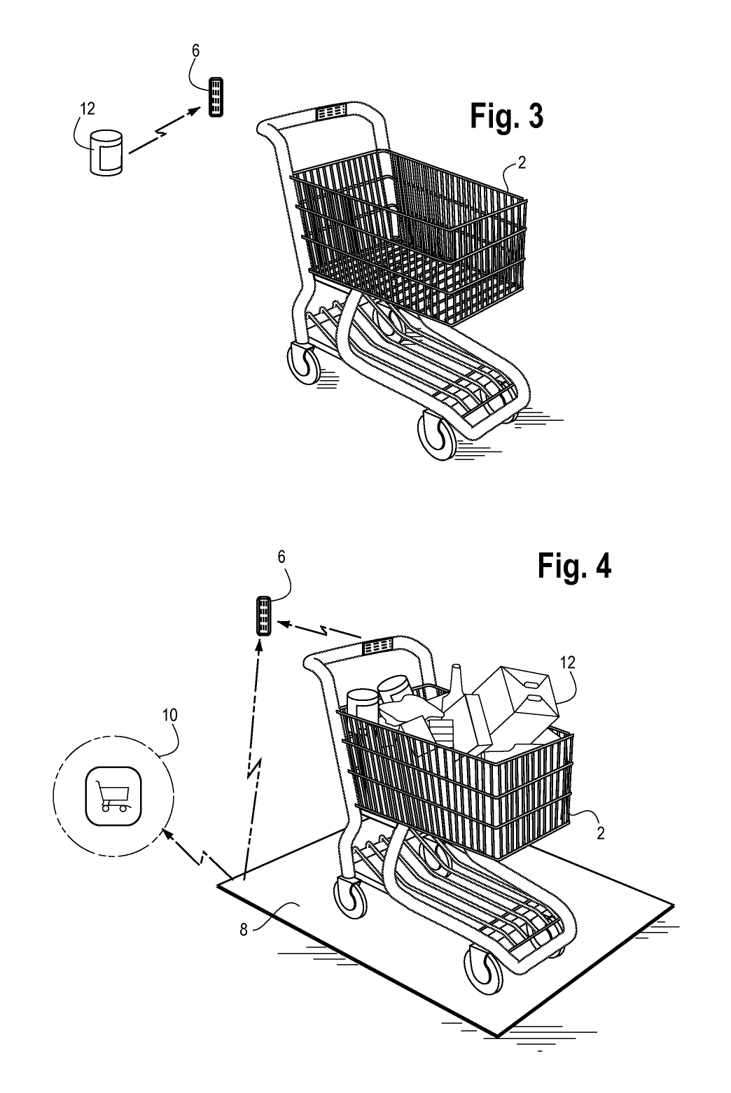

Turning to FIGS. 1-4, a receptacle 2 is chosen by a customer (not shown) and taken to the security means, depicted as a scaling area 8. The customer uses the means for identifying items 6 to first identify the receptacle 2 and then to associate the weight of the receptacle 2. The means for identifying items 6 is able to associate with a receptacle 2 by reading a tag identifier 4 on the receptacle. The means for identifying items runs software 10 that links the customer's means for identifying items to a store central computer (not shown).

After a receptacles' 2 weight is recorded within the software 10, a customer is free to shop for items for purchase 12. Throughout the store, items have a tag identifier 4 that the means for identifying items for purchase 6 is able to read. Once the item 12 is read or scanned by the means for identifying items 6, a customer is able to see the price and other relevant descriptive information about the item. A customer is able to see this because the store's central computer stores this information and allows it to be seen through use of the application software 10. If the customer desires to buy the item 12, then this is indicated within the means for identifying items 6 and the item is placed in the receptacle 2. If the customer does not want to purchase the item, it is deleted from the means for identifying items. This is repeated over and over until a customer has completed the shopping.

After shopping is complete, the customer brings the receptacle 2 back to the scaling area 4 8, as seen in FIG. 4. This post shopping weight is compared to the weight of the items 12 logged in the means for identifying items 6 plus the pre-shopping weight of the receptacle 2. If the weight is measured and found to accurate, the customer proceeds to checkout.

Checkout can be attained means for remote purchasing found within the software contained in the means for identifying items for remote purchase. The means for remote purchasing may be a credit or debit card or bank account linked to the software. Once payment is confirmed, a customer is free to leave the store with the items 12.

Preferred features of the present invention will now be described with particular reference to the accompanying drawings. However, it is to be understood that the features illustrated in and described with reference to the drawings are not to be construed as limiting on the scope of the invention.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

1. A system for providing express purchasing of items comprising:
a receptacle for holding items for purchase;
a security area for ensuring items in receptacle are the items purchased;
a device equipped with application software for identifying items for purchase and for remote purchasing;
and
a central computer linking said device for identifying items for purchase to said device for remote purchasing and said security area.

2. The system as in claim 1 wherein said receptacle is a cart or basket.

3. The system as in claim 1 wherein the security area is a scaling area for of weighing said receptacle before items are placed inside and after shopping for items is complete.

4. The system of claim 3 wherein said scaling area is a flat pad scale or other ground level scaling means.

5. The system of claim 1 wherein said device for identifying items for purchase and for remote purchasing is a cell phone, personal digital assistant, or a tablet computer equipped with a reader associated with a corresponding tag identification identifier.

6. The system of claim 1 wherein said device for identifying items for purchase and remote purchasing is a cell phone, personal digital assistant, or a tablet computer equipped with payment facilities.

7. A method for providing express purchasing of items utilizing a receptacle for holding items for purchase comprising the steps of:
scanning the receptacle with a device for identifying items for purchase and remote purchasing utilizing application software;
scanning items for purchase with said device for identifying items for purchase and remote purchasing utilizing said application software; placing items for purchase within said receptacle;
security for ensuring items in receptacle are items purchased; and
completing a purchase utilizing a central computer linking said device for identifying items for purchase and remote purchasing to said security for ensuring items in receptacle are items purchased.

8. The method as in claim 7 wherein said receptacle is a cart or basket.

9. The method as in claim 7 wherein the security for ensuring items in receptacle are the items purchased includes weighing the receptacle on a scaling area before and after items are placed inside;

10. The method of claim 9 wherein said scaling area is a flat pad scale or other ground level scaling means.

11. The method of claim 7 wherein said means for identifying items for purchase and for remote purchasing is a cell phone, personal digital assistant, or a tablet computer equipped with a reader associated with a corresponding tag identification identifier.

12. The method of claim 7 wherein said means for identifying items for purchase and for remote purchasing is a cell phone, personal digital assistant, or a tablet computer equipped with payment facilities.
